(19) United States
(12) Patent Application Publication
(10) Pub. No.: US 2026/0257446 A1
(43) Pub. Date: Sep. 3, 2026

(54) DEVICE FOR CONVERTING A STARTING MATERIAL INTO A PADDING MATERIAL FOR FILLING THE EMPTY VOLUME IN A CONTAINER, AND METHOD FOR OPERATING SUCH A DEVICE

(71) Applicant: Storopack Hans Reichenecker GmbH, Metzingen (DE)

(72) Inventors: Jean-Marc Slovencik, Rosenfeld (DE); Paul Deis, Preuschdorf (FR)

(21) Appl. No.: 18/870,860

(22) PCT Filed: Jun. 1, 2023
(86) PCT No.: PCT/EP2023/064632

§ 371 Date: Dec. 2, 2024

(30) Foreign Application Priority Data
Jun. 2, 2022 (DE) 10 2022 114 014.8

(51) Int. Cl. B31D 5/00; B26D 9/00; B26F 1/24

(52) U.S. Cl. CPC B31D 5/0043; B26D 9/00; B26F 1/24; B31D 2205/0052; B31D 2205/0058; B31D 2205/007; B31D 2205/0088

(57) ABSTRACT

A device for converting a starting material into a padding material for filling the empty volume in a container comprises a discharging section for discharging the padding material and a finishing unit which is arranged upstream of the discharging section and finishes the padding material. It is proposed that the finishing unit has a translationally movable carriage and a finishing section which is releasably and exchangeably fastened to the carriage and, by movement of the carriage, is at least partially movable into a conveying channel for the padding material.

The invention relates to a device for converting a starting material into a padding material for filling the empty volume in a container and to a method for operating such a device according to the preambles of the respective independent claims.

Devices in the form of padding conversion machines are known on the market. These have a driven conveying unit that draws a web-shaped or endless starting material made of paper, for example, into a feeding section. In the device, the starting material is, for example, crumpled and/or creased, resulting in a padding material that has a larger volume and a lower density than the starting material. The padding material is discharged via a discharging section. A finishing unit in the form of a cutting unit cuts the padding material into elongated padding cushions.

The problem underlying the invention is solved by a device and a method having the features of the independent claims. Advantageous developments are specified in dependent claims.

In the device according to the invention, the finishing section is arranged releasably and exchangeably on the translationally movable carriage. In this way, on the one hand, a worn finishing section can easily be exchanged with a new finishing section, and on the other, it is possible to attach functionally different finishing sections to the carriage and thus realize different functions of the finishing unit on the otherwise identical device. The flexibility in the use of the device according to the invention is thus considerably increased. Furthermore, with the method according to the invention, different functions of the finishing unit can be realized in a simple manner.

Specifically, this is achieved by a device for converting an initially web-shaped starting material into a padding material for filling the empty volume in a container. Such a device is also called a “padding conversion machine.” The initially web-shaped starting material can, for example, be a paper web that is wound up as a roll or provided as a concertina-folded stack. If it is provided as a roll, the paper web can be unwound flatly and evenly from the roll and then, for example, folded over at the side edges in the padding conversion machine and then crumpled. However, it is possible, and in the present case particularly preferred, if the starting material is pulled out radially from the inside of the roll in its axial direction and is drawn into the device as a spiral, tube-shaped starting material.

The device typically comprises a feeding section for feeding the starting material. If the starting material fed to the device is the spiral tube-shaped starting material just mentioned, the feeding section can be designed, for example, as a feed funnel. If the starting material is web-shaped and flat, the feeding section can have a forming unit by which the lateral edges of the starting material are folded over as it is drawn in.

Furthermore, the device typically includes a discharging section for discharging the padding material. The discharging section may have a conveying channel with a discharging opening from which the finished padding material exits and is dispensed, for example, to a user.

A driven conveying unit of the padding conversion machine is used to convey the starting material or padding material. The conveying device can, for example, comprise two rotating rollers which are arranged relative to one another in such a way that there is a small gap between their lateral surfaces. At least one of the two rollers can be driven. By rotating the rollers, the starting material is forced through the gap and is preferably deformed-for example, crumpled and/or creased. However, the conveying device can also have two pairs of rollers spaced apart from one another in a conveying direction, wherein the pair of rollers arranged downstream conveys at a lower speed than the pair of rollers arranged upstream. This compresses the material, which also leads to a crumpling effect.

Upstream of the discharging section, in the device according to the invention, a finishing unit is arranged which finishes the padding material. Typically, the finishing unit can cut the initially endless strand of padding material into individual, elongated padding cushions.

In this way, the end result is a three-dimensional padding material that has a comparatively large volume and a comparatively low density. This padding material can then be grasped, for example, by a user or, automatically, by a robot and placed into a container, such as a transport box, in order to at least partially fill any empty space there. This prevents the items contained in such a transport box from rattling around and becoming damaged during transport.

According to the invention, the finishing unit has a translationally movable carriage. This carriage is a section that is mounted on a housing of the device so that it can move back and forth-for example, by means of a linear guide. The carriage is mechanically coupled to a drive which causes the mentioned back-and-forth movement of the carriage. Typically, the drive is an electric motor, but a pneumatic or hydraulic drive is also conceivable.

A finishing section is attached to the carriage in a releasable and exchangeable manner. For example, the finishing section can be form-fittingly connected to the carriage and secured to it, for example, by a screw. However, a pure screw connection is also conceivable. Instead of a screw connection, a snap connection or something similar could be provided. For the purpose of finishing the padding material, the finishing section can be moved at least partially into a conveying channel for the padding material by moving the carriage. If the finishing section is moved into the conveying channel, it can act upon the padding material present there and rework it.

In a further development, it is provided that the finishing section include a cutting section. For example, the cutting section can be designed as a blade, in particular as an obliquely running blade. A sawtooth-like design of the cutting section is also possible. If such a finishing section is completely inserted into the conveying channel, a cushion pad mentioned above is separated from the endless strand of padding material.

In a further development, it is provided that the finishing section include a perforation section. For example, the finishing section may comprise a plurality of needle sections arranged in series. If such a finishing section is introduced into the conveying channel, the needle sections penetrate into the padding material present there without cutting it, thereby creating a perforation line in it. This allows a user to tear off a padding cushion of a desired length by hand, for example, by tearing it apart along the perforation line.

It is possible and particularly preferred that the finishing section comprise both a cutting section and a perforation section or be designed as a combined cutting and perforation section. Depending upon the penetration depth of the finishing section in the conveying channel in the padding material, it is then either only perforated (with a lower penetration depth) or separated (with a greater penetration depth).

In a further development, it is provided that the finishing section be one of a set of differently designed finishing sections. This means that the device can be adapted very quickly to different functional requirements.

In a further development, it is provided that the set of finishing sections comprise finishing sections of different lengths and/or finishing sections of different shapes. The same advantages apply here as above.

In a further development, it is provided that the carriage have a slot-like guide in which a guide block engages, which is connected to a drive and which can carry out an eccentric rotary movement. This is mechanically robust and durable.

In a further development, it is provided that the eccentric rotary movement of the guide block be carried out in one direction of rotation during one finishing operation and in an opposite direction of rotation during another finishing operation. For example, a cycle consisting of a movement of the finishing section towards the conveying channel and back again (from a top dead center to a bottom dead center and back to the top dead center) can be effected by a 360° rotation of the guide block along a circular path. In such a case, the guide block could cause the movement of the finishing section by clockwise rotation in one cycle and by counterclockwise rotation in a subsequent cycle. This evens out the wear and tear of the guide block and the guide.

In a further development, the guide block is arranged eccentrically on a drive wheel or on an elbowed crank. This is mechanically robust and durable.

In a further development, the drive of the guide block comprises a stepper motor or a motor with an encoder. This makes it possible to specifically control the drive and move it to a specific position, and thus also to specifically control the carriage with the finishing section to a specific position, and thus to specifically control or vary the penetration depth of the finishing section in the conveying channel, for example, as mentioned above, so as to only perforate during one finishing and to separate during another finishing. The control is preferably carried out by an appropriate open-loop control unit or open-loop control and closed-loop control unit for example, a computer.

The invention also includes a method for operating a device of the type described above, which comprises the following steps: a. manually actuating an input unit to trigger operation of the conveying device; b. time- or length-controlled, automatic, short-term switching off of the conveying device during the continuous actuation of the input unit; c. automatically driving the finishing unit during the short-term, automatic switching off of the conveying device so that a perforation is produced; d. ending the manual actuation of the input unit; and e. automatically driving the finishing unit after ending the manual actuation of the input unit so that the padding material is cut.

An embodiment of the invention will be explained below with reference to the appended drawings. In the drawing:

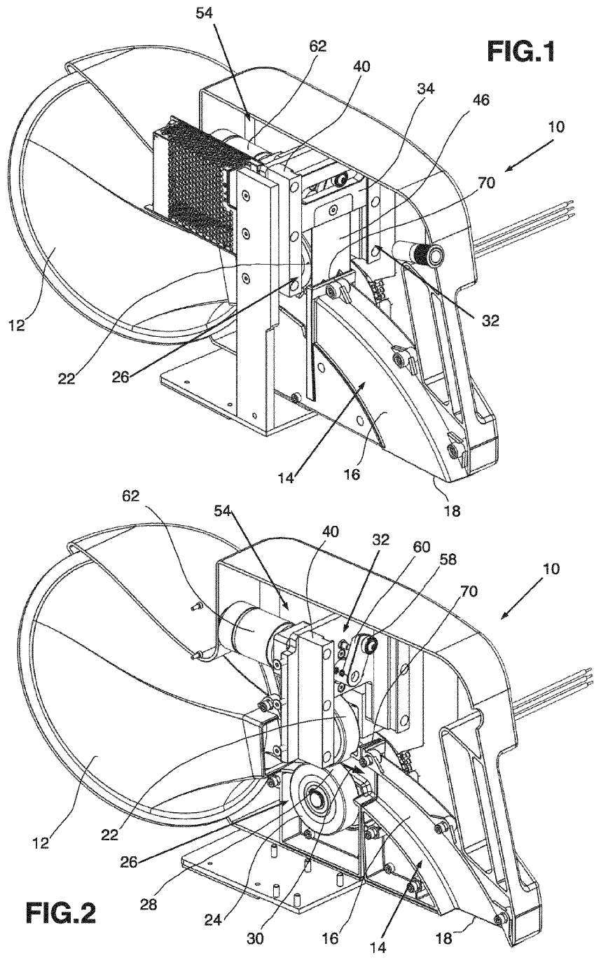

FIG. 1 is a perspectival view from the front of a device for converting a starting material into a padding material, wherein parts of the device have been removed for better visualization;

FIG. 2 is a view similar to FIG. 1, wherein even more parts of the device have been removed;

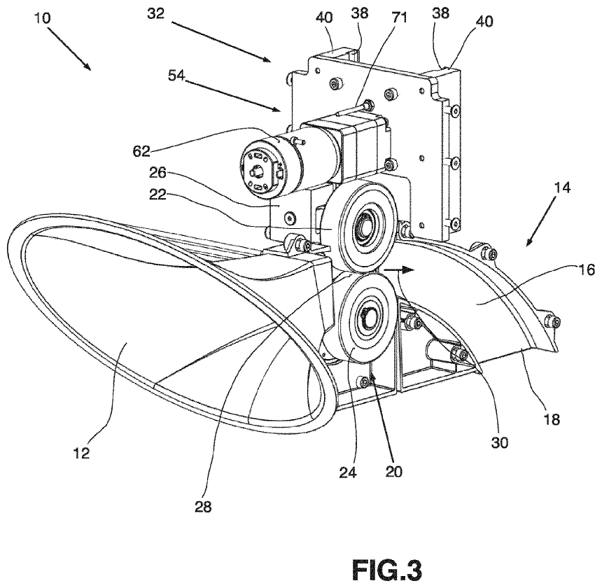

FIG. 3 is a perspectival view from behind of the device of FIGS. 1 and 2, wherein even more parts of the device have been removed;

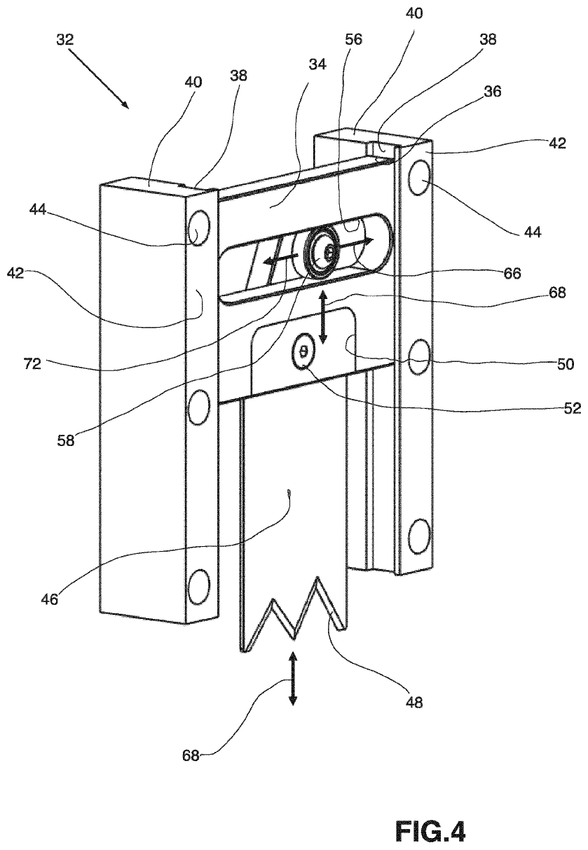

FIG. 4 is a perspectival view obliquely from the front of a finishing unit of the device of FIGS. 1-3;

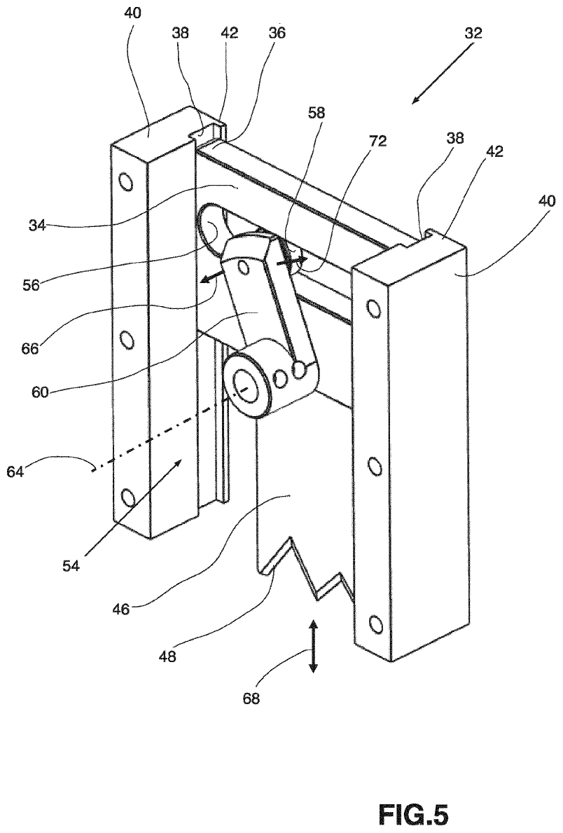

FIG. 5 is a perspectival view obliquely from the rear of the finishing unit of FIG. 4;

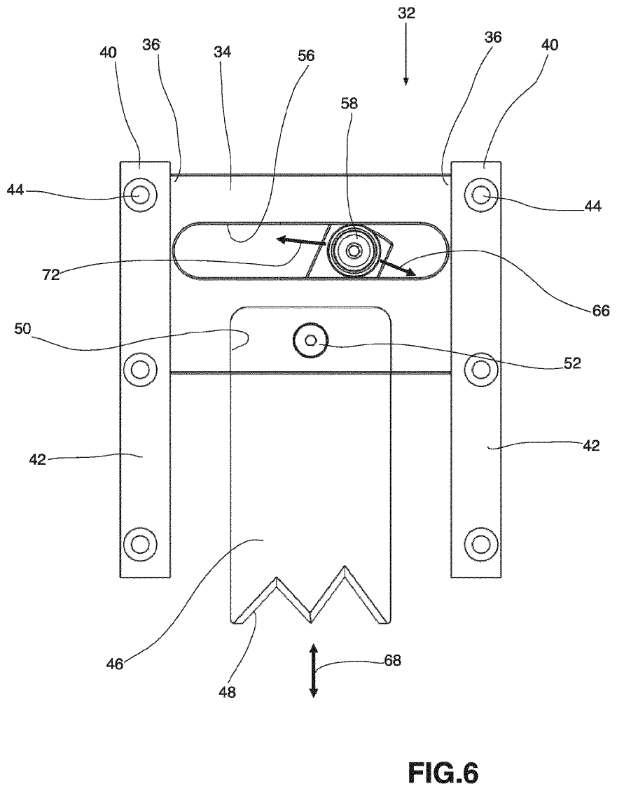

FIG. 6 is a front view of the finishing unit of FIGS. 4-5; and

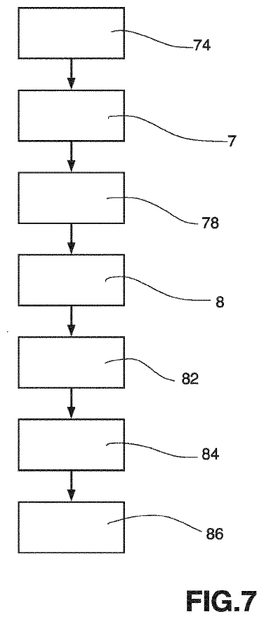

FIG. 7 is a flowchart of a method for operating the device of FIGS. 1-6.

A device for converting a starting material into a padding material is designated overall by the reference sign 10 in the figures. It is used to convert a typically initially roughly web-shaped starting material into a padding material for filling the empty volume in a container (not shown). The device 10 is also referred to as a “padding conversion machine.” The initially web-shaped starting material can, for example, be a paper web that is wound up as a roll or provided as a concertina-folded stack. If it is provided as a roll, the paper web can be unwound flatly and evenly from the roll and then, for example, folded over at the side edges in the padding conversion machine 10 and crumpled. However, it is possible, and in the present case particularly preferred, if the starting material is pulled out radially from the inside of the roll in its axial direction and is drawn into the device 10 as a spiral, tube-shaped starting material.

The device 10 comprises a feeding section 12 for feeding the starting material. In the present example, the feeding section 12 is designed as a conical feed funnel. This is particularly suitable for the above-mentioned spiral, tube-shaped starting material. In an embodiment not shown, in which the supplied starting material is web-shaped and even/flat, the feeding section can have a forming unit by means of which, for example, the lateral edges of the starting material are folded over when it is drawn in.

On the side facing the viewer in FIGS. 1 and 2, the device 10 further comprises a discharging section 14, which in the present case comprises a conveying channel 16 with a discharging opening 18. The finished padding material exits the discharging opening 18, where it can be grasped by a user, for example. The conveying channel 16 has a rectangular cross-section in the present case and is slightly curved downwards in its longitudinal direction. In addition, the cross-sectional area of the conveying channel 16 increases in the conveying direction towards the discharging opening 18.

The device 10 further comprises a conveying device 20 with which the starting material or the padding material is conveyed within the device 10, i.e., from the feeding section 12 via the conveying channel 16 in the direction of the discharging opening 18. The conveying unit 20 can be seen particularly well from FIGS. 2 and 3. In the present case, it comprises a pair consisting of two rotating rollers 22 and 24, one or both of which are driven by a drive 26.

The two rollers 22 and 24 are arranged relative to each other such that a certain gap 28 is present between their lateral surfaces (without reference sign). By rotating the rollers 22 and 24 in opposite directions, the starting material is forced through the gap 28 and driven towards the discharging opening 18. In order to be able to automatically adapt the gap 28 to different conditions, one of the two rollers 22 and 24 or both rollers 22 and 24 can be spring-mounted orthogonally to a conveying direction 30. In order to improve the conveyance of the material, the lateral surfaces of the two rollers 22 and 24 can be provided, for example, with a rubber coating or something similar (for example, a corrugation).

When the material is forced through the gap 28, it is typically at least somewhat deformed—for example, crumpled and/or wrinkled. Assuming that the starting material is the spiral, tube-shaped starting material made of paper mentioned at the outset, this is pressed, crumpled, and creased when forced through the gap 28, whereby its shape is more or less fixed and thus converted into said padding material.

In an alternative embodiment not shown, the conveying device can have two pairs of rollers spaced apart from one another in the conveying direction, wherein the pair of rollers arranged downstream is driven at a lower speed than the pair of rollers arranged upstream. This causes the material to be compressed in the conveying direction, which also leads to a crumpling effect.

In any case, at the end, i.e., at the discharging section 14, a three-dimensional padding material is obtained which has a comparatively large volume and a comparatively low density. This padding material can then be grasped, for example, by a user or, automatically, by a robot and placed into a container, such as a transport box, in order to at least partially fill any empty space there.

Upstream of the discharging section 14, more precisely as seen in the conveying direction between the feeding section 12 designed as a funnel and the conveying channel 16, a finishing unit 32 is arranged. This is shown in greater detail in FIGS. 4-6.

The finishing unit 32 initially has a carriage 34, which in the present case is designed fundamentally as a rectangular plate. The carriage 34 has two lateral edges 36, which are vertical in the figures and are received in complementary vertical grooves 38 in lateral guide elements 40. The grooves 38 can be limited by removable limiting plates 42 which are screwed to a body (without reference sign) of a guide element 40 (reference sign 44).

In an embodiment not shown, the carriage can also be guided by a linear guide with ball or roller bearings.

A finishing section 46 is releasably and exchangeably attached to the carriage 34. The finishing section 46 is designed in the present case as an approximately rectangular and elongated thin plate. At its lower edge in the figures, the finishing section 46 shown here as an example has a sawtooth-shaped cutting section 48.

In an embodiment not shown, the finishing section has a perforation section, which can be formed, for example, by a plurality of needle sections arranged in a row. A combination of perforation section and cutting section is also conceivable, in which sharp cutting sections are present between the needle sections.

In the present example, the finishing section 46 is form-fittingly connected to the carriage 34. For this purpose, the carriage has a recess 50 which is open downwards in the figures, wherein the contour of the inner wall of said recess is complementary to the outer contour of the upper section of the finishing section 46 in the figures. The finishing section 46 is secured to the carriage 34 by means of a screw 52.

In an embodiment not shown, a pure screw connection is also conceivable. Instead of a screw connection, a snap connection or something similar could be provided.

By loosening the screw 52, the finishing section 46 can be removed from the carriage 34 and exchanged, for example, with a new or another finishing section.

The carriage 34 is mechanically coupled to a drive 54. For this purpose, the carriage 34 has a guide 56. The guide 56 is designed as an—in the figures—horizontal slot in an upper region of the carriage 34. A guide block 58 of the drive 54, which in this case is designed as a rotatable roller, engages in the guide block 56 and is arranged at a projecting end of an elbowed crank 60. In an embodiment not shown, the guide block could also be arranged eccentrically on a drive wheel.

The crank 60 is connected at the end opposite the guide block 58 to a drive shaft of an electric motor drive 62. The electric motor drive 62 can comprise an electric motor and a gear flanged to it, but the crank 60 can also be mounted directly on a drive shaft of the electric motor. An axis of rotation of the crank 60 is shown in dot-dashed lines in FIG. 5 and is provided with the reference sign 64.

When the crank 60 rotates about the axis of rotation 64 by 360° in a clockwise direction (arrow 66 in FIGS. 4-6), the guide block 58 moves on a circular path (eccentric rotary movement) in the direction of the right edge of the guide block 56 in FIGS. 4 and 6 and then back to the center (bottom dead center). In this position, the carriage 34 and the finishing section 46 are moved downwards as far as possible in the figures (double arrow 68 in FIGS. 4-6). In this way, the finishing section 46 with the cutting section 48 is moved through a slot 70 (FIGS. 1 and 2) into the conveying channel 16—specifically, in the present example, such that the cutting section 48 completely traverses the conveying channel 16.

If the crank 60 is moved further clockwise until the guide block 58 is in the maximum upper position in the figures (top dead center), the carriage 34 and the finishing section 46 are moved upwards again in the figures until the finishing section 46 has completely released the conveying channel 16 again, i.e., has been completely retracted from it. It is understood that, during operation of the finishing unit 32, the conveying device 20 is preferably not in operation. By moving the cutting section 48 into the conveying channel 16, the padding material located in the conveying channel 16 is severed, so that a cut padding pad is produced from the initially endless strand, which can be removed by a user, for example, from the discharging opening 18.

After a finishing operation in which the crank 60 has been moved 360° clockwise 66, the crank 60 can be moved 360° counterclockwise in a subsequent finishing operation, as shown by the arrow 72 in FIGS. 4-6.

To control the electric motor drive 62, a sensor 71 is provided (FIG. 3), which detects when the guide block 58 is at the top dead center. In an embodiment not shown, the electric motor drive can also be equipped with a stepper motor or a motor with an encoder. This allows the position of the guide block on the circular path and thus the vertical position of the carriage and the finishing section to be precisely controlled and adjusted.

It was mentioned above that the finishing section in an embodiment not shown may comprise a combination of cutting section and perforation section. If in this case the finishing section enters the conveying channel only with the perforation section, the padding material present there would only be perforated. However, if the finishing section dips further or completely into the conveying channel and then also with the cutting section, the padding material would be severed and cut off. This could be used in a corresponding method for operating the device 10 as follows (FIG. 7):

In a function block 74, an input unit is manually actuated to trigger operation of the conveying device 20. The input unit can, for example, be a foot switch. Thus, the rollers 22 and 24 are set in rotation, and the material is transported from the feeding section 12 through the gap 28 between the rollers 22 and 24 into the conveying channel to the discharging opening 18.

In a function block 76, a time- or length-controlled, automatic, short-term switching off of the conveying device 20 takes place during the continuous actuation of the input unit. The term “automatic” is understood here to mean that a control unit controls the corresponding component in a desired manner without the intervention of an operator. The control unit can, for example, be a computer. In other words, the user continues to hold down the input unit, and yet the conveying device 20 stops automatically.

In a function block 78, the drive 54 of the finishing unit 32 is automatically started while the input unit is still actuated. However, the finishing section 46 is automatically moved by the control system only far enough into the conveying channel 16 that the padding material present there is not severed, but merely provided with a perforation. The finishing section 46 is then completely and automatically pulled out of the conveying channel 16.

Thereafter, in a functional block 80, the drive 26 with the rollers 22 and 24 is automatically started again, whereby material is again conveyed from the feeding section 12 to the discharging opening 18 (and further out of it). The padding material emerging from the discharging opening 18 is now provided with a perforation.

This process can be repeated continuously, in a time- or length-controlled manner, as long as the operator operates the input unit. In this case, “in a time- or length-controlled manner” means that, as long as the input unit is actuated, steps 76-80 are continuously repeated either after a certain time has elapsed or after a certain length of material has been conveyed. In this way, perforations are continuously introduced into the padding material at specific intervals.

This continues until, in a function block 82, the operator stops the manual operation of the input unit-for example, by taking the foot off the foot switch.

This results in the drive 26 with the rollers 22 and 24 being automatically stopped in a function block 84 and the finishing unit 32 being automatically driven in a function block 86 such that the finishing section 46 is completely immersed in the conveying channel 16, whereby the padding material is separated or cut off.

The finishing section 46 may be one of a set of several differently configured finishing sections. For example, the set of finishing sections may include finishing sections that are of different lengths or different widths. Alternatively or additionally, the set of finishing sections may comprise finishing sections that are differently shaped. For example, one finishing section of the set may include a cutting section, another finishing section of the set may include a perforation section, and another finishing section of the set may include a combined cutting and perforation section. All finishing sections of the set are designed identically in the region of the coupling to the carriage 34; so, they can all be coupled to the same carriage 34.

1. Device for converting a starting material into a padding material for filling the empty volume in a container, comprising a discharging section for discharging the padding material and a finishing unit which is arranged upstream of the discharging section and which finishes the padding material, wherein the finishing unit has a translationally movable carriage and a finishing section which is releasably and exchangeably fastened to the carriage and which can be moved at least partially into a conveying channel for the padding material by a movement of the carriage.

2. Device according to claim 1, wherein the finishing section comprises a cutting section.

3. Device according to claim 1, wherein the finishing section comprises a perforation section.

4. Device according to claim 1, wherein the finishing section is one of a set of differently designed finishing sections.

5. Device according to claim 4, wherein the set of finishing sections comprises finishing sections of different lengths and/or finishing sections of different shapes.

6. Device according to claim 1, wherein the carriage has a slot-like guide in which a guide block engages, which is connected to a drive and which can carry out an eccentric rotary movement.

7. Device according to claim 6, wherein the guide block is arranged eccentrically on a drive wheel or on an elbowed crank.

8. Device according to claim 6, wherein the drive of the guide block comprises a stepper motor or a motor with an encoder.

9. Device according to claim 6, wherein the eccentric rotary movement of the guide block is carried out in one direction of rotation during a finishing operation and in an opposite direction of rotation during another finishing operation.

10. Method for operating a device according to claim 1, comprising the following steps:
a. manually actuating an input unit for triggering an operation of the conveying device;
b. time- or length-controlled, automatic, short-term switching off of the conveying device during the continuous actuation of the input unit;
c. automatically driving the finishing unit during the short-term, automatic switching off of the conveying device so that a perforation is produced;
d. ending the manual actuation of the input unit; and
e. automatically driving the finishing unit after the manual actuation of the input unit has ended so that the padding material is cut.
